(19) United States
(12) Patent Application Publication
(10) Pub. No.: US 2024/0407346 A1
(43) Pub. Date: Dec. 12, 2024

(54) FOLDABLE LANDING NET

(71) Applicant: Russell HANTON, Winnellie (AU)

(72) Inventor: Russell HANTON, Winnellie (AU)

(21) Appl. No.: 18/699,625

(22) PCT Filed: Oct. 7, 2022
(86) PCT No.: PCT/AU2022/051205

§ 371 Date: Apr. 9, 2024

(30) Foreign Application Priority Data
Oct. 25, 2021 (AU) 2021903401
Jul. 27, 2022 (AU) 2022902099

(51) Int. Cl. A01K 77/00

(52) U.S. Cl. CPC A01K 77/005

(57) ABSTRACT

An angler landing net is disclosed comprising a handle and a two-part net support, the two parts pivotally connected about two pivot points to allow opening and closing of the net. The pivot point near the handle has a locking mechanism with an elongate locking pin movable from a housing in the handle to pass through aligned apertures in the ends of the net support parts to lock them in the open position, and movable back into the handle to fold the net. After opening the net, the user rotates a protrusion on the elongate locking pin to lock it into a channel

The present patent right claims priority to AU2022902099 filed on 27 Jul. 2022 and AU2021903401 filed on 25 Oct. 2021 the contents of which are hereby incorporated by reference in their entirety.

### TECHNICAL FIELD

The present invention relates to an angler's landing net.

### BACKGROUND

Angling is a method of fishing using a fishhook or angle. The hook is attached to a fishing line which is usually manipulated by a fishing rod. When the fish is hooked on the hook, the fishing line is wound around a reel and the fish is drawn closer to the angler who subsequently collects the fish from the water.

Most anglers know that the use of a landing net will increase the number of fish caught or “landed”. As the line is wound and the fish is drawn closer, the landing net can be used to scoop the fish from the water. In addition to improving success rate for the angler, the use of a landing net is arguably better for the fish. This can be especially true if the fish is large, and the weight of the fish causes the hook to tear its flesh during the landing process. Accordingly, a landing net can be useful when fishing is “catch and release” since the fish suffers less and is less damaged when returned to its natural environment.

When an angler hooks a fish, typically they must react quickly to keep the fish hooked and to successfully catch/land the fish. A problem with some landing nets is that during the process of manipulating the net to catch the fish, the fish is lost. The angler is holding the fishing rod at the same time as using the landing net, which requires considerable dexterity. The angler must grab the net, make sure that the net material is not tangled and is free and able to catch the fish, then the net is dipped into the water, all while maintaining focus and attention on the hooked fish. Some landing nets can be large to accommodate big fish such as carp.

However, the larger the landing net the more difficult it is to transport and the more potential for tangling of the net material in the hurry to use it to land a fish.

The present invention seeks to ameliorate at least some of the problems of the prior art or at least to provide a useful alternative.

### SUMMARY OF INVENTION

### Exemplary Embodiment A

In a first aspect there is provided an anglers landing net comprising
a handle having a first end and a second end;
a net support arranged at or towards a first end of the handle, a junction formed at the location where the net support joins the handle, the net support for supporting a net in use that is configured to catch a fish therein; the net support being provided in two net support parts pivotally connected to one another about two pivot points so as to be foldable to a closed, storage, position and openable to an open, in use, position,
the two net support parts comprising a first net support part having a first end and a second end; and a second net support part having a first end and a second end;
wherein the two pivot points comprise a first pivot point and a second pivot point, and the first ends of the net support parts meet at the first pivot point at or near the junction formed between the handle and net support and the second ends of the net support parts meet at the second pivot point; and
a locking mechanism arranged at the first pivot point, wherein the locking mechanism comprises an elongate locking pin associated with the handle, the elongate locking pin movable to pass through aligned apertures in both the first ends of the net support parts to thereby lock them in the open position; the elongate locking pin movable out of at least one of the aligned apertures in one of the first ends of the net support parts so thereby allow one of the net support parts to be foldable about the pivot points to the closed position.

To embodiments will now be described exemplary embodiment A and exemplary embodiment B. These alternative embodiments each have different locking mechanisms, but the nets other wise have the same intended effect in use.

### Exemplary Embodiment A and B

In embodiments, the present landing net lends itself to fast operation, heavy duty design and ease of use. In an embodiment, the present landing net may solve the problem of the time it takes to engage operation, by way of a locking mechanism that is easy to use and secure once in either the open or closed positions.

The present anglers landing net can also be referred to as a fishing net or simply “a net”. The net is robust enough to allow for the landing of fish weighing in the range of from about 3 kg to about 20 kg. However, while this range is provided it should be understood that the landing net could be used to land smaller fish or much larger fish. More than one fish can be collected by the net at one time. Furthermore, the net does not have to be used just for landing fish and may also be used for transporting and or carrying fish, and otherwise performing task related to the overall fishing experience.

The handle of the angler's landing net should be firm and robust and of a size that allows the user's hand to firmly grip it to manipulate the net part disposed at one end. The handle can have a substantially circular cross-section although other cross-sections can be accommodated. In a preferred embodiment, the net handle is squared (with smooth edges). The squared side walls can be about 40 mm×40 mm with a wall thickness 2.5 mm. While these dimensions are provided as exemplary, it should be understood that other dimensions could be accommodated. The handle can be hollow to reduce the amount of material used to form it and to decrease the overall weight of the product. A hollow handle may also be preferred since the landing net will then have a tendency to float if dropped into the water. In some embodiments, the handle can be injected with buoyant floatation foam to further increase the buoyancy of the landing net. In a preferred embodiment, the handle is made from aluminium. A grip can be provided on the handle. The grip can be heat resistant rubber. In an embodiment, the can handle retract into itself for more travel convenience. The handle could be telescopic and or comprise a snap pin midway along the length of the handle.

The length of the handle can define a longitudinal axis for the landing net. The handle can be at least about 1 m in length to allow the user to extend the net part into the water to catch the fish. The handle can be shorter or longer as required. In some embodiments, the handle is telescopically or otherwise adjustable by the user to the required length according to their location and or arm length.

The handle has a first end and a second end. A net support can be arranged at the first end of the handle. In this embodiment, the first end terminates at the location where the net support starts, and the second end is free. The net support can be arranged towards the first end of the handle meaning that it is not exactly at the end of the handle and some of the handle extends further into the area defined by the net support periphery.

The net support is a ring-like extension from the handle. The ring-like net support can define an inside area which once bounded by net is the area into which a fish will be caught. The ring-like net support can have a plane that is flat and not twisted. The plane of the ring like net support can be in line with the longitudinal axis of the handle. In some embodiments, the plane of the ring like net support can be slightly offset from the longitudinal axis of the handle to improve the likelihood of catching the fish when using the net standing on land.

While the net-support is described as ring-like, it should be understood that the net support does not have to be circular and instead can have straight sides around the outer rim. In an embodiment, the net support is substantially triangular shaped having two arm parts extending away from the junction where the handle and net support meet, and having one arm part joining the arm parts together to form the triangle. The net support can also be square shaped or any other variation in shape that provides the net support area. In a preferred embodiment, the net support is hexagonally shaped. A hexagon is a strong, functional shape for landing fish. A hexagon is smart and modern looking and is a popular shape in nature. Furthermore, the hexagonal shape tessellates well for packaging. The sides of the hexagon (or other polygon) can be the same length or of different lengths as desired. In an embodiment, each side of the hexagon is in the range of from about 700 mm to about 1500 mm, preferably at least about 900 mm.

The net support can be a thin rod of material that has some flex. The net support can be a solid piece of material that does not flex. The net support can be formed from a net tube. The net tube can have a circular cross-section. The net tube can have some other cross-section such as a triangular shaped cross section (preferably with rounded edges). In an embodiment, the net support tube can have a wall thickness of about 2.5 mm and is made from aluminium.

The net support is for supporting a net. The net can be any material known for use with landing nets. The net can be attached to the net support by a material belt. In embodiments, the net can be disconnectable to allow it to be replaced. The user may have a variety of different net materials that can be added according to the use requirements. However, preferably the net material is not disconnectable from the net support which increases its robustness and reduces any likelihood that the net material will be inadvertently removed from the net support by the thrashing and or heavy fish in use.

The net support is provided in two net parts. There can be a first net support part and a second net support part. Each of the first and second net support parts can be formed from one continuous piece of material. Each net support part can be formed from multiple pieces of material joined to one another to form the overall structure. Each net support part once formed can be substantially identical to the other of the net parts, although there is no reason that they could not be different in size and or shape. The net support parts are connected to one another. The net support parts are pivotally connected to one another. Thus, the net support parts are able to move relative to one another about two pivot points. The net support parts can be folded/pivoted towards one another into a closed position. The net support parts can contact one another when in the closed position. In the closed position, when the net is attached, the net will bunch up, but the overall size/dimensions of the net support of the landing net is decreased. This decrease in size can be advantageous for storage and travel. When traveling with fishing gear, large and bulky items can be difficult to manage, especially nets with large ring-like apertures that don't fit into the vehicle or pose a bulky inconvenience when walking to the fishing venue. Once in the closed position, the folded landing net at the net support part may have dimensions less than about 1000 mm.

When in the closed position, the net support parts can be attached to one another to stop the net from accidentally (inadvertently) re-opening. A button strap can be provided to wrap around the net support parts and hold them into the closed position. Any means for securing the two net support parts together could be used including hook and loop type fastener, latch, ties or buttons.

In addition to being pivotally connected to one another, the net support parts can each be hingedly attached to the handle of the landing net. A junction is formed at the location where the net support joins the handle. At this junction, there can be provided a hinge that allows the folded net support parts in the closed position to be folded towards the handle. This allows the landing net to be folded to a small configuration for storage and travel.

The pivot connection between the net support parts can be formed by each net support part being attached to a pivot rod about which the parts pivot. A first end of the first net support part can terminate in at least one passageway through which the pivot rod can pass. A first end of the second net support part can terminate in at least one passageway through which the pivot rod can pass. The pivot rod can be shaped at one end to ensure that the net support parts cannot be removed from the pivot rod once it has been inserted through the aligned passageways. The first ends pivoting about the pivot rod can be a first pivot point. There can be two pivot points including the first pivot point and a second pivot point. As outlined above, the first ends of the net support parts can meet at the first pivot point at or near the junction formed between the handle and net support. The second ends of the net support parts meet at the second pivot point.

### Exemplary Embodiment A

The net support parts can pivot around each of the first and second pivot points from a closed position to an open position. When in the open position, each of the net support parts, as they extend from the first pivot point can have a substantially common longitudinal axis. In an embodiment, the first ends of the net support parts can have complementary shapes, so that once in the open position, the net support parts are unable to move any further open relative to one another. This means that once in the open position, they are fixed in the openmost position with the substantially common longitudinal axes formed for the net support parts. The shape of the end part of each first end of the net support part be a cut-away L-shape. The two first ends can nest with one another in the configurations L and 1, this being best shown in the Figures. However, it should be understood that each first end is shaped so as to allow movement relative to the other, but so that there is a stop provided by each respective end to the other to avoid further rotation past a certain point. The nesting of each first end when in the open position can provide an aesthetically appealing junction, in addition to it being more structurally stable since any further stresses applied at the pivot connection are absorbed into the solid structures.

Each end part of the first ends of the net support parts comprises an aperture formed therein. When in the open position, and abutted with one another, the apertures can align to provide a common passageway. An item such as a solid piece of material can be inserted into the aligned apertures. Once in the aligned apertures, the solid piece of material would be housed in both end parts i.e. the end part of the first end of the first net part and the end part of the first end of the second net part. When the end parts of the net support parts are moved to the closed position (or any position between open and closed) the apertures are not aligned. The apertures can be of any cross-sectional shape including circular, square, triangular. In a preferred embodiment, the apertures are circular in cross section providing a cylindrical inner space that allows for free rotation of anything inserted into the aligned apertures once so located.

An aim of inserting an item into the aligned apertures of the first end parts is to cause them to be locked together relative to one another. With an item in the aligned apertures, the rotation of each end part about the first pivot point is substantially prevented. With this in mind, the solid piece of material that can be inserted into the aligned apertures of the end parts can be referred to as a locking pin. The locking pin can be an elongate piece of solid material, such as metal, that is slidable into and out of the apertures. Metal is a suitable material since it is strong and not easily bendable under rotational pressure, although other strong materials that can cause the two net parts to be locked relative to one another an be used such as strong plastic.

The elongate locking pin can slide into the end part of the first end of the first net support part and then into the end part of the first end of the second net support part, before being secured into position in the aligned apertures. The aperture in each end part can be through the whole body of each end part. However, it should now be understood that the aperture must be through the whole body of the first end of the first net part so any locking pin inserted therethrough can access the aperture in the end of the second end part. While on the other hand the aperture in the second end part may be through the whole body, but it does not have to be through the whole body so long as enough of the body of the end part of the first end of the second part is accessible by the locking pin to house the pin and thereby prevent rotation thereof relative to the other end part.

As described above, the elongate locking pin can be movable to pass through the aligned apertures in both the first ends of the net support parts to thereby lock them in the open position. The elongate locking pin can be movable out of at least one of the aligned apertures in one of the first ends of the net support parts to thereby allow at least one of the net support parts to be foldable about the pivot points to the closed position. By “at least one” of the aligned apertures it is meant that the locking pin can move out of one of the apertures (i.e. the aperture in the end part of the first end of the net support part); or both of the apertures. By: to thereby allow “at least one” of the net support parts to be foldable, it is meant that if the locking pin is moved out of only one of the apertures (i.e. the aperture in the end part of the first end of the net support part) then only the first end of the second net support part will be pivotable around the first pivot point; in this scenarios, the first end of the first net support part remains locked by the elongate locking pin. This can be an advantage since at least one of the net support parts is immovable even in the closed position. If one of the net support parts is immovable, then the net is more stable in the closed position and the user will find that the parts do not spin about the handle and hit them in the shins every time they try to relocate the net during packing, storage and transportation.

The elongate locking pin can be a separate pin to the foldable landing net. However, when the locking pin is separate, there is a chance it will be lost between uses. The locking pin could be tethered to the landing net, but this would be annoying. Having to look after a separate piece of the net that is essential to its proper use is undesirable. In a preferred embodiment, therefore, the locking pin is permanently integrated with the handle of the landing net. The elongate locking pin can be associated with the handle by providing it slidingly mounted to the handle. The elongate locking pin can slide towards the locking mechanism and into the apertures present in its path (advanced). The elongate locking pin can slide away from the locking mechanism and out of the apertures present in its path (retracted). In an embodiment, the elongate locking pin is housed in a housing provided on the handle. The elongate locking pin can move longitudinally into and out of the housing. Furthermore, the elongate locking pin can be rotatable about it's a longitudinal axis while in the housing. The elongate locking pin is reasonable small relative to the landing net. To facilitate in using it, the elongate locking pin can have a little user handle that allows the user to advance or retract it. The little user handle can be anything that makes it easier for the user to grip and move the pin. In an embodiment, the elongate locking pin comprise a protrusion. The protrusion can be an elongate rod extending perpendicularly from the elongate locking pin. While it can be perpendicular, any angle offset from this that still allows it to be held can be used. The protrusion allows the user to manipulate the locking pin into and out of the aligned apertures of one or both of the of the first ends of the net support parts. As the locking pin rotates about its longitudinal axis, the protrusion would move with the pin, so the user can move the protrusion to a laying flat position against the handle or an upwards and engaging position where they can grip it readily.

Preferably the elongate locking pin is fixable in either the advanced or retracted position. If the elongate locking pin is not fixed into position, as the user manipulates the net it is possible the pin will slide around uncontrollably, and this could be inconvenient if the parts lock or unlock at a time when they are better held fixed. When the elongate locking pin passes through aligned apertures in the first ends of the net support parts to thereby lock them in the open position, the elongate locking pin can be locked into that open position by rotation of the elongate locking pin which causes the protrusion on its body to slide into a channel. The channel can be formed by two walls that are configured to receive the protrusion between then. The channel can substantially prevent further longitudinal movement (advancement or retraction) of the locking pin by holding the protrusion. The pin can be held into the channel by any means including a gate or other barrier that hold it into the channel. A gate could be liftable to open let the protrusion into the channel and then movable to close it. The protrusion could be held in the channel by a magnet which attracts the protrusion and does not readily release it without some manual force to overcome the magnetic forces. In an embodiment, the protrusion is held in the channel by interference fit. To optimise any the interference fit, the channel can be occluded by a locking bar over which the protrusion can pass into the channel. The locking bar can be a small device that allows passes of the protrusion into the channel, but which prevents easy exit from the channel without the applicant of manual force. In order to put the protrusion into the channel, the user need only rotate the elongate locking pin around its longitudinal axis and the protrusion will slide into the channel. The user might need to force the protrusion over the locking bar. To release the elongate locking pin, the user presses their finger or thumb onto the end of the protrusion and lifts it up over the locking bar.

In the closed position, the elongate locking pin is retracted out of at least the aperture in the first end of the second net support part and can be locked into that closed position by holding it against advancement movement. The means for holding the locking pin into the unlocked or closed position can be a gripper. The gripper can be anything that prevents advancement such as a channel with a openable/closable gate, a magnet that attracts the protrusion and or an interference fit. In an embodiment, the gripper provides an interference fit of the protrusion into a channel into which the protrusion can pass but which prevents exit from the channel without the application of some manual force. In order to retract the elongate locking pin the user pulls it out of the apertures, clicks the elongate pin into the gripper. To release, the user presses the elongate locking pin out of the gripper and advances it forward into the apertures.

### Exemplary Embodiment B

In an alternative embodiment, there is provided an anglers landing net comprising a handle having a first end and a second end; a net support arranged at or towards a first end of the handle, a junction formed at the location where the net support joins the handle, the net support for supporting a net in use that is configured to catch a fish therein; the net support being provided in two net support parts pivotally connected to one another about two pivot points so as to be foldable to a closed, storage, position and openable to an open, in use, position; the two net support parts comprising: a first net support part having a first end and a second end; and a second net support part having a first end and a second end; wherein the two pivot points comprise a first pivot point and a second pivot point, and the first ends of the net support parts meet at the first pivot point and the second ends of the net support parts meet at the second pivot point; and a locking mechanism arranged at least at the junction formed between the handle and net support, wherein the locking mechanism locks the net support parts into the open position.

The net support can be at the terminus of the first end of the handle. A hinge can be provided at the junction formed at the location where the net support joins the handle so that the net support can be folded towards the handle. The locking mechanism can comprise a lock lever arranged at the first end of the first net support part, configured to engage with a lock housing arranged the first end of the second net support part. There can be two locking mechanisms, one at each of the two pivot points. The locking mechanism at the first pivot point can be as previously described in this paragraph, and the locking mechanism at the second pivot point can comprise a lock lever arranged at the second end of the first net support part, configured to engage with a lock housing arranged the second end of the second net support part. The lock lever can comprise an elongate body with a tapered head. The lock housing can comprise a body defining a passageway, and the tapered head of the lock lever passes through the passageway of the lock housing. The lock lever can be spring loaded to assist in locking the lock lever into a locked position once the tapered head of the lock lever has passed through the passageway of the lock housing. The lock lever can be locked into the lock housing by interference fit. A locking pin can be provided to further lock the lock lever into the lock housing.

At the pivot point located at the junction where the net support joins the handle, the net support parts can include a locking mechanism comprising a lock lever and a lock housing. The lock lever can be located at the first end of the first support part. The lock lever can be configured to interlock with the lock housing provided at the first end of the second net support part. When the lock lever is inserted into the lock housing, the first and second support parts are locked into the open position.

Optionally, in addition to the locking mechanism at the junction, the other pivot point between the net support parts remote from the handle can include a locking mechanism. The locking mechanism can be the same or different to that described in the immediately preceding paragraph only the second ends of the net support parts are now the subject.

In an embodiment, the lock lever (at the first or second ends of the net support parts) can comprise an elongate body having a tapered head. The body of the lock lever can extend generally in a direction away from the terminal end of the first support part. The lock lever can be spring-loaded so as to be biased into a locking position. As the net support parts are opened, the tapered head of the lock lever (on the first net support) can move towards the lock housing (on the second net support) and the tapered head can facilitate the lock lever passing into the lock housing. As the net support parts are brought more fully to the open position, the lock lever is biased towards the locking position and may engage with the housing by a step in the tapered head. Thus, the net support parts are locked into the open position. In order to close the net support parts, a pressure can be applied to the head of the lock lever to overcome the spring bias and allow the lock lever to exit the lock housing as the net support parts are gently brought together into the closed position.

In the embodiment described in the previous paragraph, the lock housing can be an aperture through which the lock lever passes. However, in other embodiments, the lock housing can be a channel into which the lock lever is disposed by tight interference fit.

In the embodiment described above, the lock lever is not manipulated by the user and instead is configured to pass into the housing upon the action of the net support parts being moved into the open position. However, in some embodiments, the lock lever may require some manual manipulation to fully engage it with the lock housing.

As described above, where the lock lever is spring biased, a pressure can be applied to the head of the lock lever to overcome the spring bias and allow the lock lever to exit the lock housing as the net support parts are gently brought together into the closed position. Where there are two locking mechanisms, pressure is applied to both of the tapered heads of the locking mechanism at the same time to disengage both lock levers from the lock housings.

In some embodiments, in which the lock lever is not spring biased but in which an interference fit is utilised, the user may manually remove the lock lever from the housing to effect closing of the net support parts.

While the lock lever(s) can be used to hold the net into the open position, to provide additional security, a locking pin can be provided at the locking mechanism at the junction. The locking pin can slide through an aperture in the hinge and extend over the top of the lock lever once in the lock housing. By providing a barrier at the housing on the side opposite to the locking head, the locking pin ensures that the locking lever cannot be pulled through the lock housing until the locking pin is released. In embodiments, the locking pin can comprise a pull ring to allow the user to more readily manipulate it.

### BRIEF DESCRIPTION OF THE FIGURES

Embodiments of the invention will now be described with reference to the accompanying drawings which are not drawn to scale and which are exemplary only and in which:

### Exemplary Embodiment B

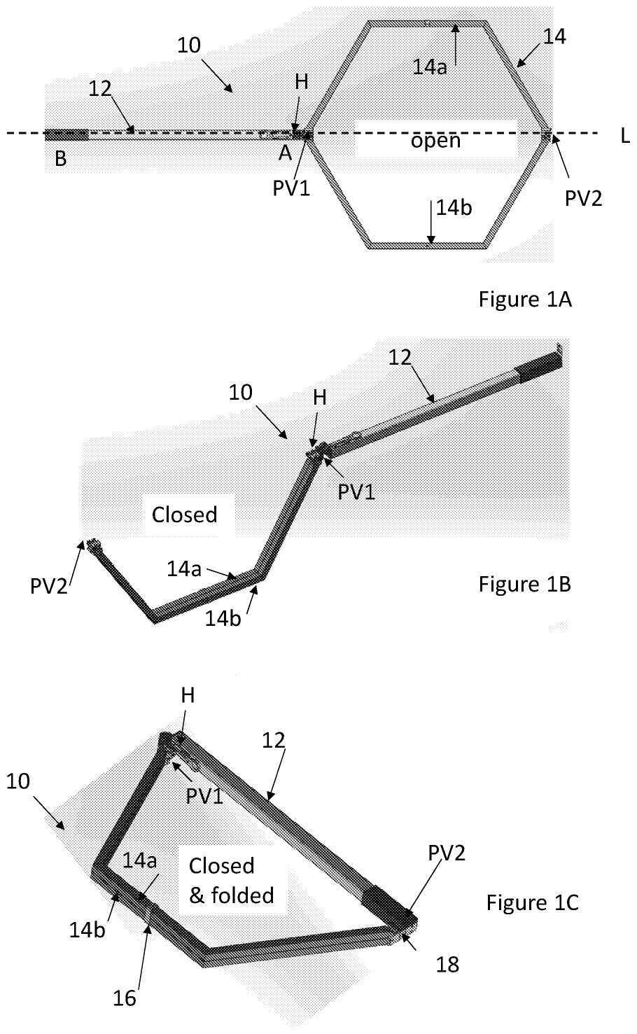

FIG. 1A is a plan view of the anglers landing net in the open position according to a first embodiment. FIG. 1B is the anglers landing net of FIG. 1A in the closed position. FIG. 1C is the anglers landing net of FIG. 1A in the closed and folded position.

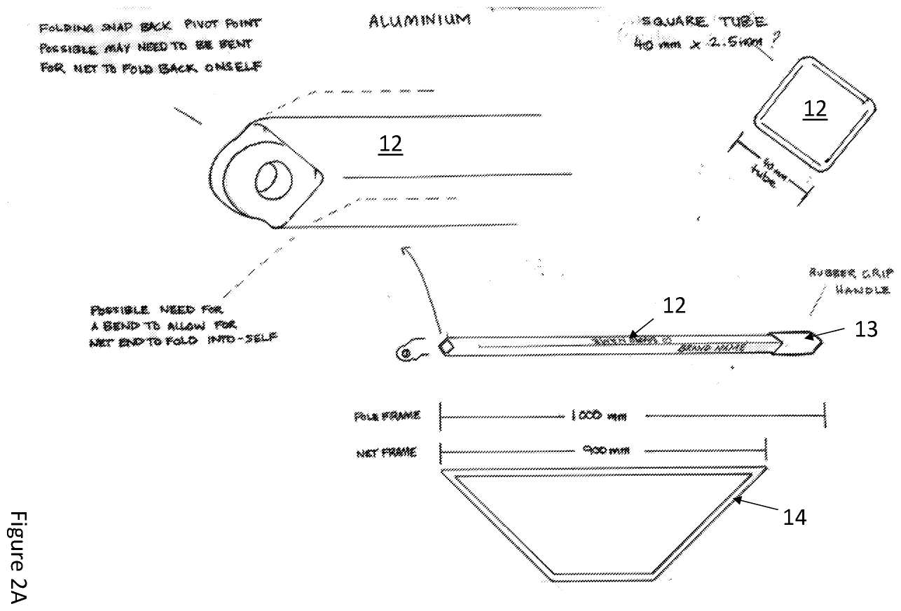

FIG. 2A shows concept drawings of the anglers landing net including cross-sections of the handle, and perspective views of the handle and the folded net support. FIG. 2B shows more concept drawings of the net in the open in use position, a cross section of the net support part, and a cross-section of the handle and net support when folded.

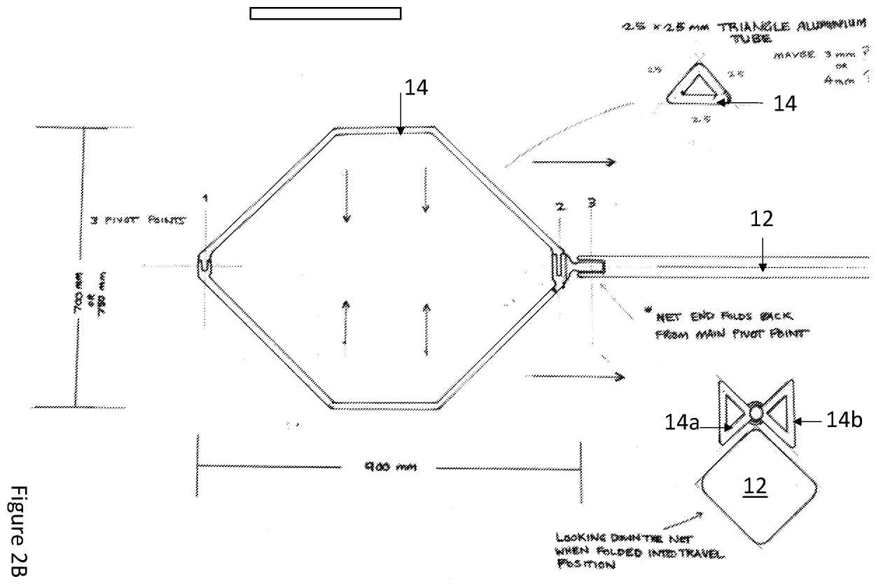

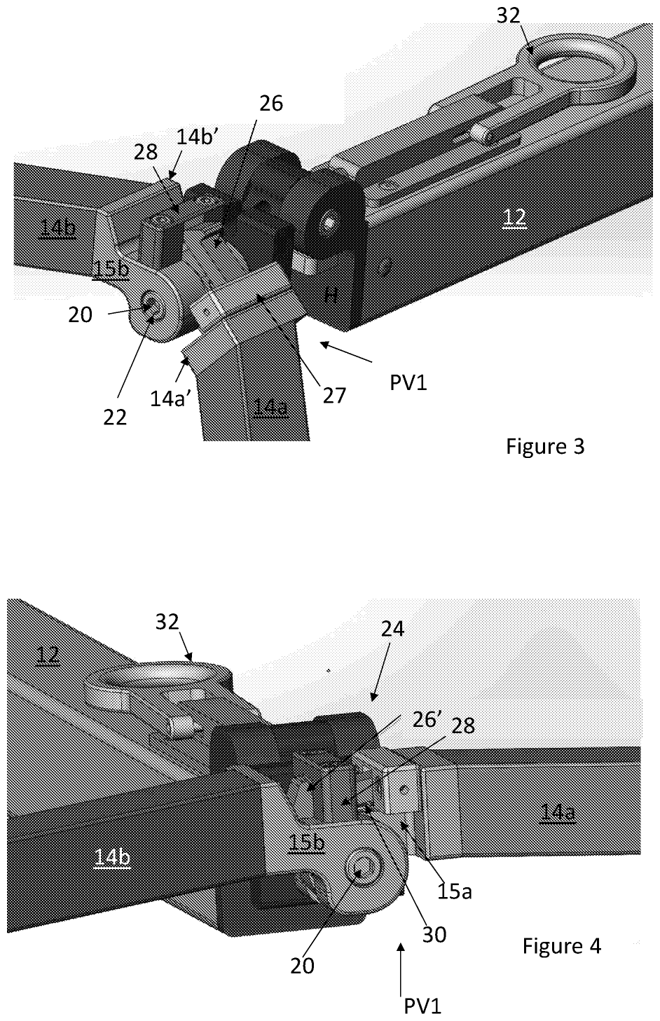

FIG. 3 is a close up of an embodiment of the locking mechanism at pivot point PV1.

FIG. 4 is a close up from a different perspective of the locking mechanism of FIG. 3.

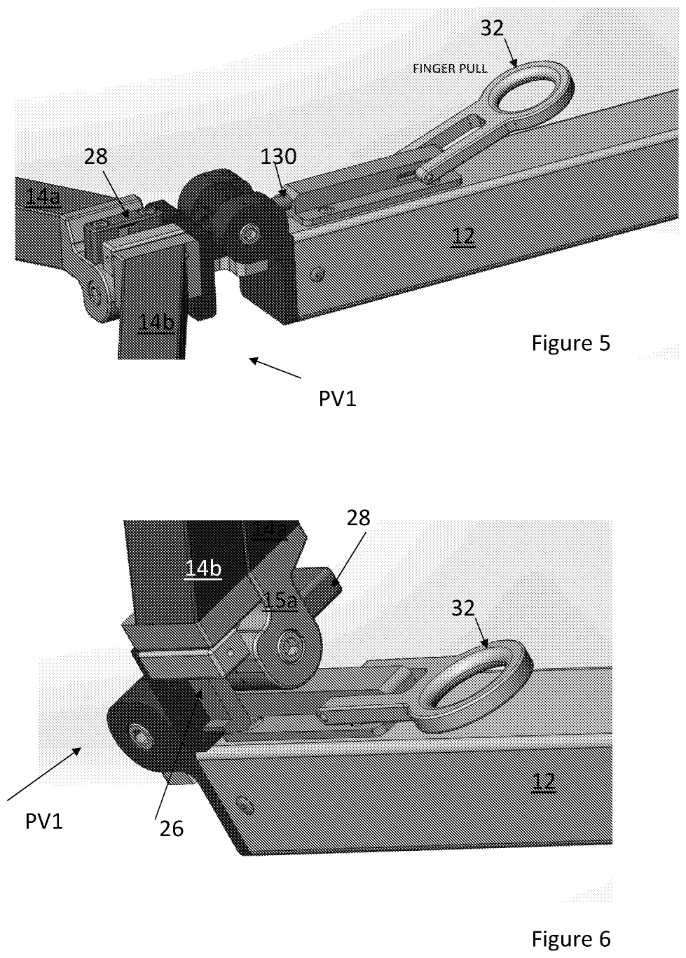

FIG. 5 is a close up of the locking mechanism of FIGS. 3 and 4 when in the open in use position.

FIG. 6 is a close up of the locking mechanism of FIGS. 3 and 4 when in the closed, storage position.

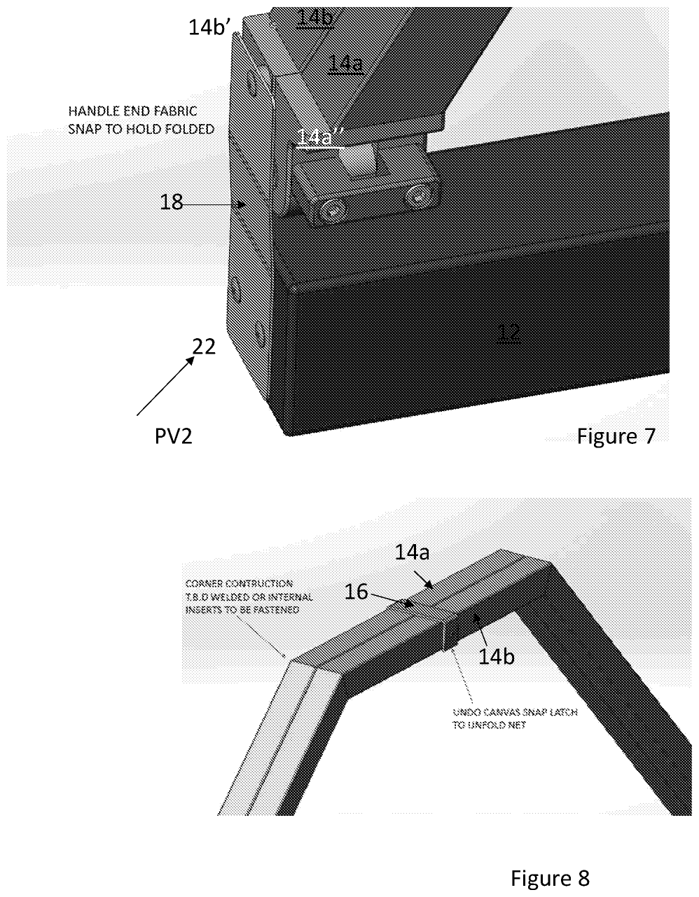

FIG. 7 is a close up of pivot point PV1.

FIG. 8 is a close up of the net support parts in the closed position.

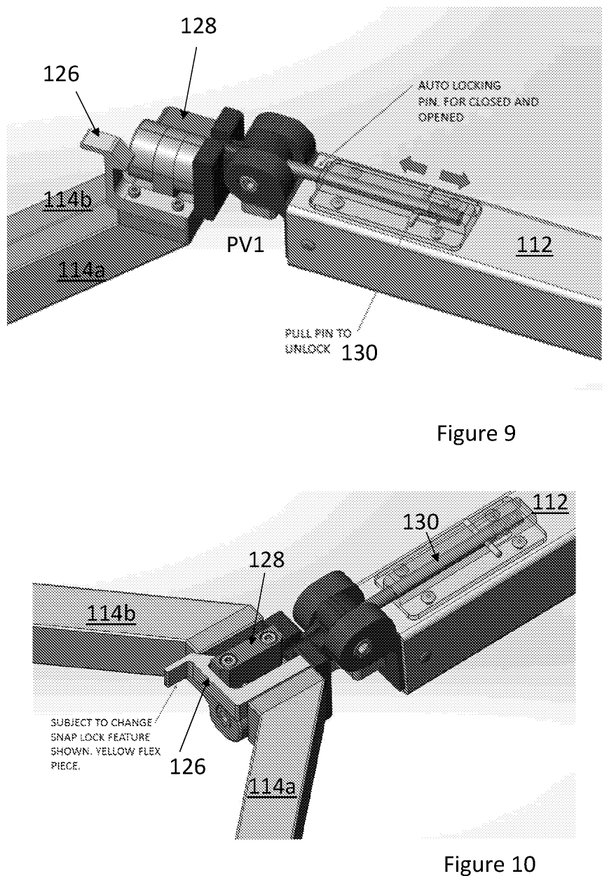

FIG. 9 is a close up of an alternative embodiment of the locking mechanism at pivot point PV1.

FIG. 10 is a close up from a different perspective of the locking mechanism of FIG. 9.

### Exemplary Embodiment A

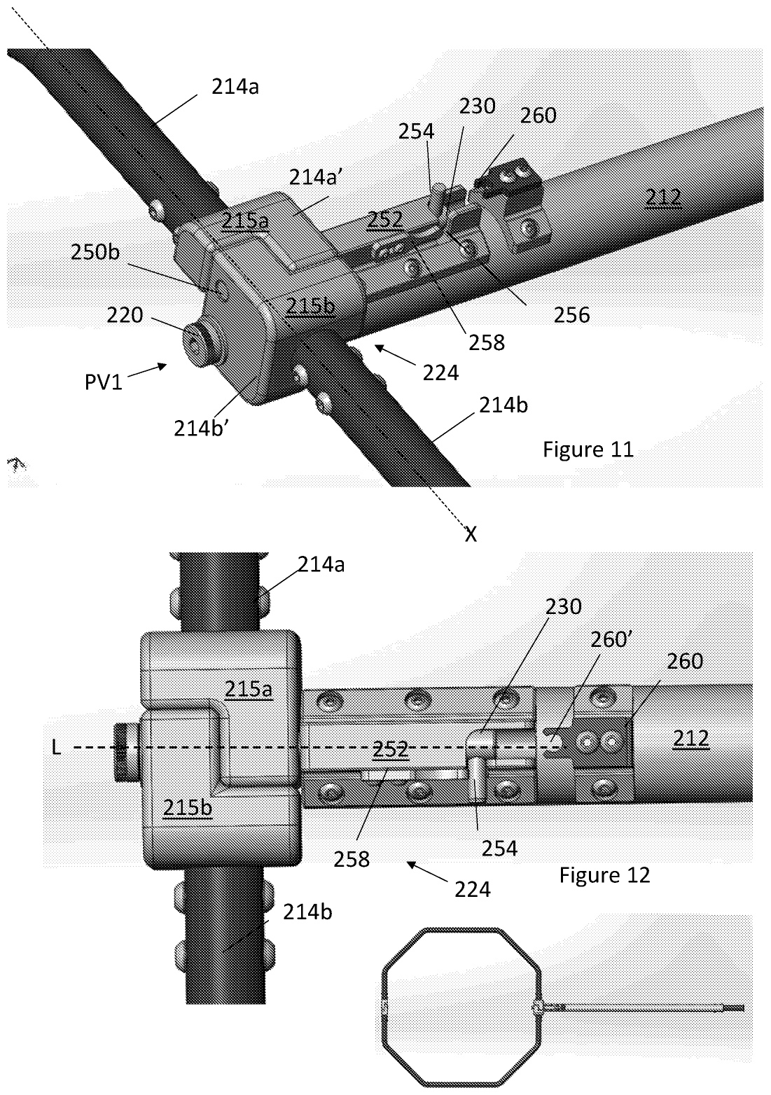

FIG. 11 is a perspective close up of a further alternative embodiment of the locking mechanism at pivot point PV1 when in the open in use position with the locking pin advanced.

FIG. 12 is a top close up of the mechanism of FIG. 11 including an inset that shows the whole anglers landing net in the open position.

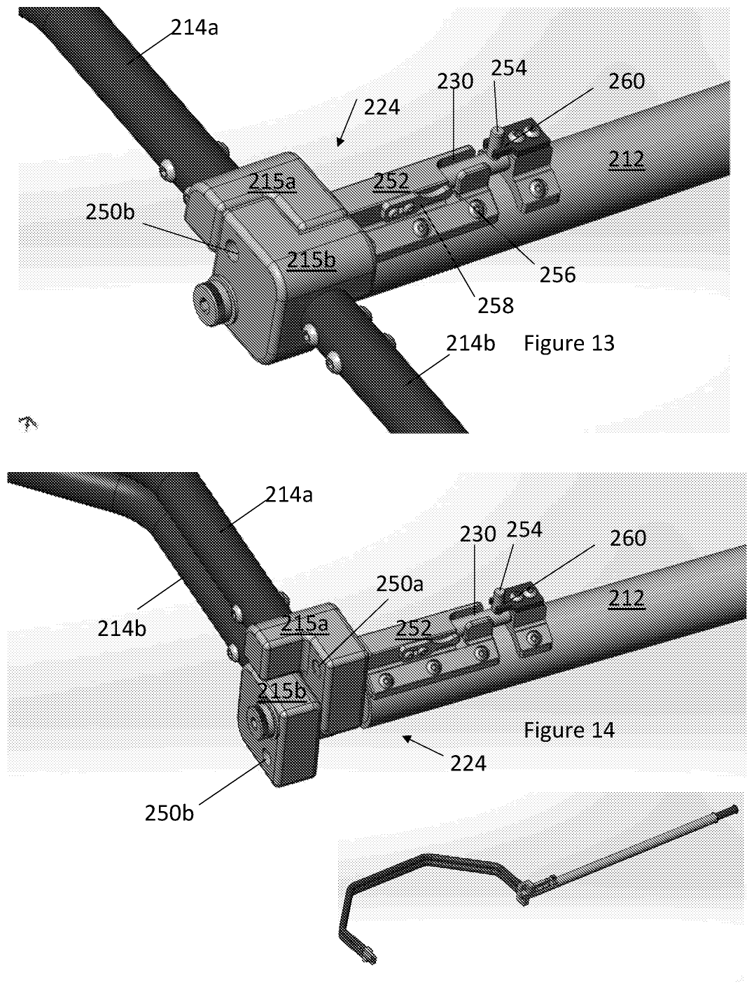

FIG. 13 is a perspective close up of the mechanism of FIG. 11 when in the open in use position, about to move to the closed position, with the locking pin retracted.

FIG. 14 is a perspective close up of the mechanism of FIG. 13 when in the closed, storage position with the locking pin retracted, including an inset that shows the whole anglers landing net in the closed position.

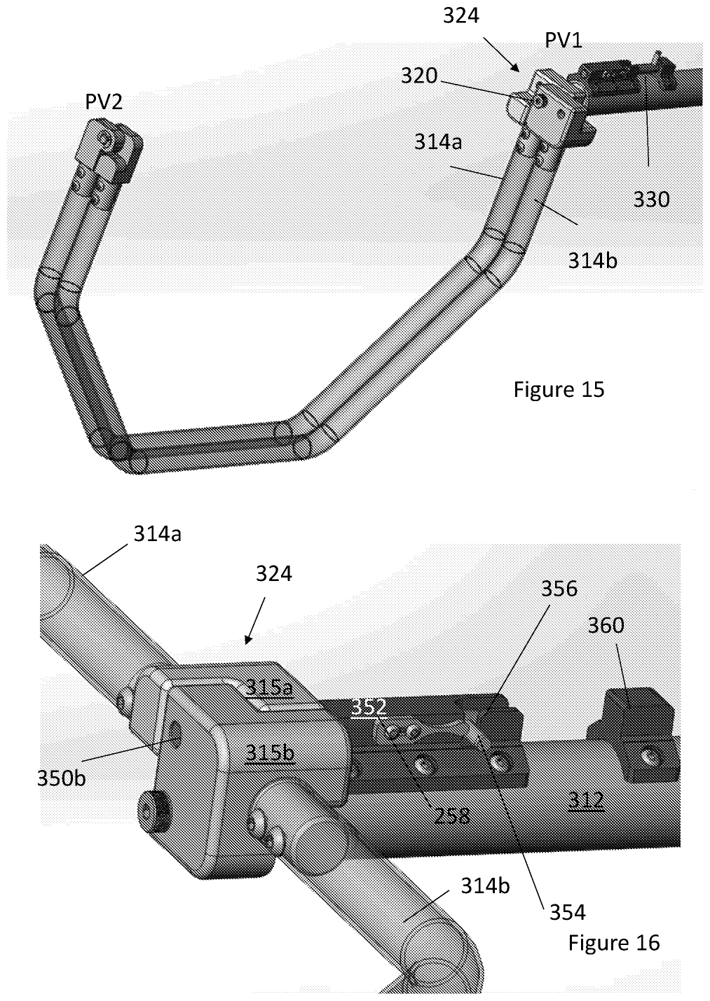

FIG. 15 is a perspective view of an alternative embodiment of the locking mechanism at pivot point showing PV1 when in the closed in use position with the locking pin advanced from both first ends of the net support parts.

FIG. 16 is a close up of the mechanism of FIG. 14 showing the locking pin advanced and in the open position.

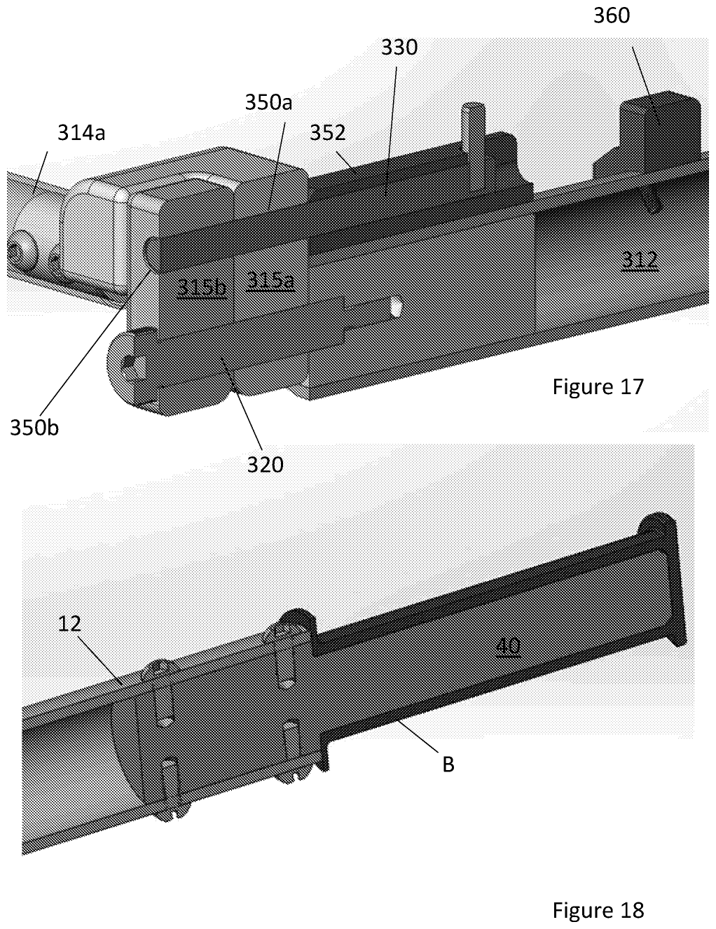

FIG. 17 is a cut away of the embodiment of FIG. 16 showing the inside materials of the locking mechanism.

FIG. 18 is a cut away of the embodiment of FIG. 16 showing the inside materials of the handle.

### DETAILED DESCRIPTION OF EMBODIMENTS OF THE INVENTION

### Exemplary Embodiment A and B

FIG. 1 shows an embodiment of an anglers landing net 10 in open position in use (FIG. 1A). The net is not shown for clarity. The length of the handle 12 defines a longitudinal axis L for the landing net 10. The handle shown is about 1 m in length. The handle 12 has a first end A and a second end B. A rubber grip can be provided at the second end B. FIG. 18 shows a cross section of how the second end B can be reinforced internally using filler material 40. The filler material 40 can be metal. It should be understood that there can be less material 40 used than that shown. A net support 14 can be arranged at the first end A of the handle. In this embodiment, the first end A terminates at the location where the net support starts, and the second end B is free.

The net support 14 is a ring-like extension from the handle. The ring-like net support 14 can define an inside area which once bounded by net is the area into which a fish will be caught. The ring-like net support 14 has a plane that is flat. The plane of the ring like net support 14 is in line with the longitudinal axis L of the handle 12.

While the net-support 14 is described as ring-like, it should be understood that the net support is hexagonally shaped. In the embodiment shown in FIG. 1, each side of the hexagon is about 900 mm in length.

The net support is provided in two net parts 14a, 14b. There is a first net support part 14a and a second net support part 14b. Each of the first and second net support parts 14a, 14b is identical in shape. The net support parts 14a, 14b are connected to one another. The net support parts 14a, 14b are pivotally connected to one another about pivot point PV1 and pivot point PV2. Thus, the net support parts are able to move relative to one another about two pivot points PV1, PV2. The net support parts 14a, 14b can be folded/pivoted towards one another into a closed position as shown in FIG. 1B and FIG. 1C. The net support parts 14a, 14b can contact one another when in the closed position. In the closed position, when the net is attached, the net will bunch up, but the overall size/dimensions of the net support 14 of the landing net is decreased. This decrease in size can be advantageous for storage and travel. When traveling with fishing gear, large and bulky items can be difficult to manage, especially nets with large ring-like apertures that don't fit into the vehicle or pose a bulky inconvenience when walking to the fishing venue.

When in the closed position, the net support parts 14a, 14b can be attached to one another to stop the net from accidentally (inadvertently) re-opening. A button strap 16 can be provided to wrap around the net support parts 14a, 14b and hold them into the closed position. FIG. 8 also shows the net support parts 14a, 14b in the closed position and held to one another with snap latch 16.

In addition to being pivotally connected to one another, the net support parts 14a, 14b can each be hingedly attached to the handle 12 of the landing net. A junction is formed at location A where the net support 14 joins the handle 12. At this junction at A, there can be provided a hinge H that allows the folded net support parts 14a, 14b in the closed position to be folded towards the handle 12. This is shown in FIG. 1C. This additional folding allows the landing net to be folded to an even smaller configuration for storage and travel.

FIG. 2A and FIG. 2C are concept drawings of an original design. The handle 12 of the angler's landing net 10 is shown as squared (with smooth edges). The handle 12 is also shown as hollow to reduce the amount of material used to form it and to decrease the overall weight of the product. A grip 13 can be provided on the handle 12. The grip 12 can be heat resistant rubber. The squared side walls of handle 12 can be about 40 mm×40 mm with a wall thickness 2.5 mm. In FIG. 2B, the net support 14 is shown as a thin hollow rod of material that has some flex. The net tube 14 is shown with a triangular shaped cross section (preferably with rounded edges). The dimensions 25×25×25 mm can be with smooth edges for reduced drag through the water. In an embodiment, the net support tube 14 can have a wall thickness of about 2.5 mm and is made from aluminium. While these dimensions are provided as exemplary, it should be understood that other dimensions could be accommodated. Any dimensions shown in FIG. 2 are exemplary only.

The pivot connection PV1 or PV2 between the net support parts 14a, 14b can be formed by each net support part 14a, 14b being attached to a pivot rod 20 about which the parts pivot. Pivot point PV1 is show in close up in FIGS. 3 and 4. The first end 14a′ of the first net support part 14a can terminate in an arm 15a having at least one aperture 22, through which the pivot rod 20 can pass. A first end of the second net support part can terminate in at least one aperture through which the pivot rod can pass. The pivot rod 20 can be shaped at one end to be larger than aperture 22 to ensure that the arms 15a, 15b of net support parts 14a, 14b cannot be removed from the rod 20 once it has been inserted through the aligned apertures 22.

### Exemplary Embodiment B

At the pivot point PV1 located at the junction where the net support 14 joins the handle 12 (shown in FIGS. 3 and 4), the net support parts 14a, 14b can include a locking mechanism 24 comprising a lock lever 26 and a lock housing 28. The lock lever 26 can be located at the first end 14a′ of the first support part 14a. The lock lever 26 can be configured to interlock with the lock housing 28 provided at the first end 14b′ of the second net support part 14b. When the lock lever 26 is inserted into the lock housing 28, the first and second support parts 14a and 14b are lockable into the open position.

Optionally, in addition to the locking mechanism 24 at the junction at A, the other pivot point PV2 between the net support parts 14a, 14b remote from the handle at B can include a locking mechanism 24. This is shown in the closed position FIG. 7. The locking mechanism at B can be the same or different to that described in the immediately preceding paragraph only the second ends 14a″ and 14b″ of the net support parts 14a, 14b are now the subject.

In an embodiment as shown in FIGS. 3 to 6, the lock lever 26 can comprise an elongate body having a tapered head with a stepped part 26′. The body of the lock lever 26 can extend generally in a direction away from the terminal end 14a′ of the first support part 14a. Optionally, the lock lever 26 is mounted on a support 27. The lock lever 26 can be spring-loaded, the spring 30 best seen in FIG. 4. The spring 30 can bias the lock lever 26 into a locking position where the stepped part 26′ of the tapered head engages against the housing 28 and is prevented from being pulled out of the housing 28.

As the net support parts 14a, 14b, are opened (see FIG. 3), the tapered head of the lock lever 26 can move towards the lock housing 28. The tapered head can facilitate the lock lever 26 from passing into a passageway formed in the lock housing. As the net support parts 14a, 14b are brought more fully to the open position, the lock lever 26 is biased towards the locking position and may engage with the housing 28 by the step 26′ in the tapered head. Thus, the net support parts 14a, 14b are locked into the open position as shown in FIG. 5. In order to close the net support parts 14a, 14b, a pressure can be applied to the head 26 of the lock lever 26 to overcome the spring bias and allow the lock lever 26 to exit the lock housing 28 as the net support parts 14a, 14b are gently brought together into the closed position (shown in FIG. 6 in the closed position).

In the embodiment described in the previous paragraph, the lock housing 28 can be an aperture or passageway through which the lock lever 26 passes as shown in FIGS. 3 to 6. However, in other embodiments shown in FIGS. 9 and 10, the lock housing 128 can define a channel into which the lock lever 126 is disposed by tight interference fit.

As described above, where the lock lever 26 is spring biased, a pressure can be applied to the head of the lock lever 26 to overcome the spring bias and allow the lock lever 26 to exit the lock housing 28 as the net support parts 14a, 14b are gently brought together into the closed position. Where there are two locking mechanisms at PV1 and PV2, pressure is applied to both of the tapered heads of the locking mechanism at the same time to disengage both lock levers 26 from the lock housings 28. In other embodiments, in which the lock lever 126 is not spring biased but in which an interference fit is utilised, the user may manually remove the lock lever 126 from the housing 128 to effect closing of the net support parts 114a, 114b.

While the lock lever(s) 26 can be used to hold the net supports 14a, 14b into the open position, to provide additional security, a locking pin 30 can be provided at the locking mechanism 24 at the junction at A. The locking pin 30 can slide through an aperture in the hinge H and extend over the top of the lock lever 26 once in the lock housing 28. By providing a barrier at the housing 28 on the side opposite to the locking head 26′, the locking pin 30 ensures that the lock lever 26 cannot be pulled through the lock housing 28 until the locking pin 30 is released by pulling finger pull 32. In embodiments, the locking pin 30 can comprise a pull ring 32 to allow the user to more readily manipulate it.

In operation, to use the landing net 10, the user unclips button strap 18 on handle 12, unclips latch 16. Unfolds hex frame 14a, 14b from handle 12 until auto spring loaded (pull-ring 32) chute bolt 30 lines up and engages with locking hole. Hex frame 14 has spring loaded auto locking latch 24 at each pivot point PV1, PV2 that engage once hex frame 14 is opened in full open position. To disengage press down on both hex frame locking latch lever buttons 26 to fold hex frame 14 to closed position, pull pull-ring 32 to relieve spring loaded chute bolt 30 from lock position and fold main chute bolt knuckle H into closed travel position.

### Exemplary Embodiment A

When in the open position, each of the net support parts 214a 214b, as they extend from the first pivot point PV1 can have a substantially common longitudinal axis X. In an embodiment, the first ends 214a′ 214b′ of the net support parts 214a 214b can have complementary shapes, so that once in the open position as shown in FIG. 11, the net support parts 214a 214b are unable to move any further open relative to one another. This means that once in the open position, they are fixed in the openmost position shown with the substantially common longitudinal axes X. The shape of the end part 215a 215b of each first end 214a′ 214b′ of the net support parts 214a 214b be a cut-away L-shape. The two end parts 215a 215b of first ends 214a′ 214b′ can nest with one another in the configurations L and 1, as shown in FIG. 11. In top view as shown in FIG. 12, there is a contact between end parts 215a and 215b which prevents further pivotal movement. There is essentially a stop provided by each respective end 215a 215b which stops the other end from further rotation.

Each end part 215a 215b of the first ends 214a′ 214b′ of the net support parts 214a 214b comprises an aperture 250a 250b formed therein. When in the open position, and the first ends parts 215a 215b are abutted with one another, the apertures 250a 250b can align to provide a common passageway 250. An item such as a solid piece of material can be inserted into the aligned apertures 250a 250b. Once in the aligned apertures 250a 250b, the solid piece of material would be housed in both end parts 215a 215b i.e. the end part 215a of the first end 214a′ of the first net part 214a and the end part 215b of the first end 215b′ of the second net part 214b. When the end parts 215a 215b of the net support parts 214a 214b are moved to the closed position (or any position between open and closed) the apertures 250a 250b are not aligned (as shown e.g. in FIG. 14). The apertures 250a 250b are shown in the figures as circular in cross sectional shape.

With an item in the aligned apertures 250a 250b, the rotation/pivot movement of each end part 215a 215b about the first pivot point PV1 is substantially prevented. With this in mind, the solid piece of material that can be inserted into the aligned apertures 250a 250b of the end parts 215a 215b can be referred to as a locking pin 230.

The elongate locking pin 230 can slide into the end part 215a of the first end 214a′ of the first net support part 214a and then into the end part 215b of the first end 214b′ of the second net support part 214b, before being secured into position in the aligned apertures 250a 250b. The aperture 250a 250b in each end part 215a 215b can be through the whole body of each end part 215a 215b (as shown). However, it should now be understood that the aperture 250a must be through the whole body of the first end 214a′ of the first net part 214a so any locking pin 230 inserted therethrough can access the aperture 250b in the end 215b of the second end part 214b′. While on the other hand the aperture 250b in the second end part 215b may be through the whole body of 215b, but it does not have to be through the whole body 215b so long as enough of the body 215b of the end part 215b of the first end 214b′ of the second net part 214b is accessible by the locking pin 230 to house the pin 230 and thereby prevent rotation thereof relative to the other end part 215a.

As described above, the elongate locking pin 230 can be movable to pass through the aligned apertures 250a 250b in both the first ends 214a′ 214b′ of the net support parts 214a 214b to thereby lock them in the open position (FIG. 11). The elongate locking pin 230 can be movable out of at least one of the aligned apertures 250 in one of the first ends 214′ of the net support parts 214 to thereby allow at least one of the net support parts 214 to be foldable about the pivot points PV1 Pv2 to the closed position (e.g. FIG. 14). The locking pin 230 can move out of one of the apertures 250b. If the locking pin 230 is moved out of only one of the apertures 250b as shown in FIG. 14 then only the first end 214b′ of the second net support part 214b will be pivotable around the first pivot point PV1; in this scenario, the first end part 215a of the first net support part 214a remains locked by the elongate locking pin 230.

The elongate locking pin 230 is shown associated with the handle 212 by providing it slidingly mounted to the handle 212. The elongate locking pin 230 can slide towards the locking mechanism 224 and into the apertures 250a 250b present in its path (advanced). The elongate locking pin 230 can slide away from the locking mechanism 224 and out of the apertures 250a 250b present in its path (retracted). In an embodiment, the elongate locking pin 230 is housed in a housing 252 provided on the handle 212. The elongate locking pin 230 can move longitudinally into and out of the housing 252. Furthermore, the elongate locking pin 230 can be rotatable about it's a longitudinal axis L while in the housing (refer FIG. 12). To facilitate in using pin 230, the elongate locking pin 230 can have a little user handle 254 that allows the user to advance or retract it. In an embodiment, the elongate locking pin 230 comprise a protrusion 254 which serves as a little user handle. The protrusion 254 can be an elongate rod 254 extending perpendicularly from the elongate locking pin 230. The protrusion 254 allows the user to manipulate the locking pin 230 into and out of the aligned apertures 250a 250b of one or both of the of the first ends 241a′ 214b′ of the net support parts 214a 214b.

When the elongate locking pin 230 passes through aligned apertures 250a 250b in the first ends 214a′ 214b′ of the net support parts 214a 214b, to thereby lock them in the open position, the elongate locking pin 230 can be locked into that open position by rotation of the elongate locking pin 230 around axis L which causes the protrusion 254 on its body to slide into a channel 256. The channel can be formed by two walls that are configured to receive the protrusion 254 between then, this is best seen in top view in FIG. 12. The channel 256 can substantially prevent further longitudinal movement (advancement or retraction) of the locking pin 230 by holding the protrusion 254. In an embodiment, the protrusion 230 is held in the channel 256 by interference fit. To optimise any the interference fit, the channel 256 can be occluded by a locking bar 258 over which the protrusion 254 can pass into the channel 256. The locking bar 258 can be a small device that allows passes of the protrusion 254 into the channel 256, but which prevents easy exit from the channel 256 without the applicant of manual force. In order to put the protrusion into the channel 256 as in FIG. 12, the user need only rotate the elongate locking pin 230 around its longitudinal axis L and the protrusion 254 if in the right position will slide into the channel 256. The user might need to force the protrusion 254 over the locking bar 258. To release the elongate locking pin 230, the user presses their finger or thumb onto the end of the protrusion 254 and lifts it up over the locking bar 258 (FIG. 11).

In the closed position, the elongate locking pin 230 is retracted out of at least the aperture 250b in the first end 214b′ of the second net support part 214b and can be locked into that closed position by holding it against advancement movement. In an embodiment, a gripper 260 provides an interference fit of the protrusion 230 into a channel 260′ into which the protrusion 260 can pass but which prevents exit from the channel 260′ without the application of some manual force. This can be seen best in FIG. 12 where the locking pin 230 is advanced so the gripper 260 is free and viewable. In order to retract the elongate locking pin 230 the user pulls it out of the aperture(s) 250, clicks the elongate pin 230 into the gripper 260 (as shown in FIG. 14). To release, the user presses the elongate locking pin 230 out of the gripper 260 and advances it forward into the apertures 250.

In FIG. 17, an alternative embodiment is shown where pin 330 with protrusion 354 is shown in the advanced position with its body in both apertures 350a 350b. The protrusion 354 is located into channel 356 and is held in place by locking pbar 358. The locking mechanism 324 prevents pivotal movement of the net support parts 314a 214b and end parts 315a 215b are in close contact with one another providing a strong open connection. To close the net support parts 314a 214b, the pin 330 is retracted as shown in FIG. 15. The pin 330 engages with gripper 360. In this embodiment the gripper 360 can be a magnet that firmly traps the pin 330 to its body 360 but which allows the user to disengage with manual force. As shown in FIG. 15, the pin 330 in this embodiment can be retracted from both apertures 350a and 350b because the distance from the channel 354 and the gripper 360 is larger and allows for greater movement of the pin 330 compared to e.g. the embodiment of FIG. 11. Both of net support parts 314a 314b can move freely about PV1 around rod 320.

A cross-section of all the parts is shown in FIG. 17 where the elongate locking pin 330 is shown advanced through apertures 350a 350b in end parts 315a 315b. The pivot point around rod 320 can also be seen in cross section.

It is notable that that the locking pin 330 is completely encased inside the locking mechanism 354 which reduces any unwanted movement or interference with the locking pin 330 during use. Furthermore, the locking pin 330 is easily accessible by the user and has a sliding motion which means that the pin 330 can be engaged and disengaged quickly between uses.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Any promises made in the present description should be understood to relate to some embodiments of the invention and are not intended to be promises made about the invention as a whole. Where there are promises that are deemed to apply to all embodiments of the invention, the applicant/patentee reserves the right to later delete them from the description and does not rely on these promises for the acceptance or subsequent grant of a patent in any country.

1. An anglers landing net, comprising:
a handle having a first end and a second end;
a net support arranged at or towards a first end of the handle, a junction formed at the location where the net support joins the handle, the net support for supporting a net in use that is configured to catch a fish therein, the net support being provided in two net support parts pivotally connected to one another about two pivot points so as to be foldable to a closed, storage, position and openable to an open, in use, position; and
the two net support parts comprising a first net support part having a first end and a second end, and a second net support part having a first end and a second end;
wherein the two pivot points comprise a first pivot point and a second pivot point, and the first ends of the net support parts meet at the first pivot point at or near the junction formed between the handle and net support and the second ends of the net support parts meet at the second pivot point; and a locking mechanism arranged at the first pivot point,
wherein the locking mechanism comprises an elongate locking pin associated with the handle, the elongate locking pin movable to pass through aligned apertures in both the first ends of the net support parts to thereby lock them in the open position; and
wherein the elongate locking pin is movable out of at least one of the aligned apertures in one of the first ends of the net support parts to thereby allow at least one of the net support parts to be foldable about the pivot points to the closed position.

2. The anglers landing net according to claim 1, wherein the elongate locking pin is housed in a housing provided on the handle, wherein the elongate locking pin can move longitudinally into and out of the housing, and can rotate about a longitudinal axis of the elongate locking pin while in the housing.

3. The anglers landing net according to claim 1, wherein the elongate locking pin comprises a protrusion that allows manipulation of the locking pin into and out of the aligned apertures of one or both of the of the first ends of the net support parts.

4. The anglers landing net according to claim 3, wherein, when the elongate locking pin passes through aligned apertures in the first ends of the net support parts to thereby lock them in the open position, the elongate locking pin is locked into that open position by rotation of the elongate locking pin which causes the protrusion thereof to slide into a channel which thereby prevents further longitudinal movement of the locking pin.

5. The anglers landing net according to claim 4, wherein the protrusion is held in the channel by interference fit.

6. The anglers landing net according to claim 5, wherein the interference fit provided is occluded by a locking bar over which the protrusion can pass into the channel, but which prevents an exit from the channel without manual force.

7. The anglers landing net according to claim 1, wherein when the elongate locking pin passes out of the aperture in the first end of the first net support part to thereby allow one of the net support parts to be foldable about the pivot points to the closed position, and the elongate locking pin being locked into that closed position by a gripper.

8. The anglers landing net according to claim 7, wherein the gripper provides an interference fit of the protrusion into a channel into which the protrusion can pass but which prevents exit from the channel without manual force.

9. The anglers landing net according to claim 1, wherein a hinge is provided at the junction formed at the location where the net support joins the handle so that the net support can be folded towards the handle.

10. The anglers landing net according to claim 1, further comprising a second locking mechanism at the other of the pivot points.

11. The anglers landing net according to claim 1, wherein each of the first ends terminates in an end part in which the apertures are provided.

12. The anglers landing net according to claim 11, wherein each end part is configured to provide a nesting fit with the other end part when in the open position.

13. The anglers landing net according to claim 1, further comprising the net.

14. A method of using an anglers landing net, the method comprising:
providing the anglers landing net, comprising: a handle having a first end and a second end; a net support arranged at or towards a first end of the handle a junction formed at the location where the net support joins the handle, the net support for supporting a net in use that is configured to catch a fish therein, the net support being provided in two net support parts pivotally connected to one another about two pivot points so as to be foldable to a closed, storage, position and openable to an open, in use position; and the two net support parts comprising a first net support part having a first end and a second end, and a second net support part having a first end and a second end; wherein the two pivot points comprise a first pivot point and a second pivot point, and the first ends of the net support parts meet at the first pivot point at or near the junction formed between the handle and net support and the second ends of the net support parts meet at the second pivot point, and a locking mechanism arranged at the first pivot point, wherein the locking mechanism comprises an elongate locking pin associated with the handle, the elongate locking pin movable to pass through aligned apertures in both the first ends of the net support parts to thereby lock them in the open position; and wherein the elongate locking pin is movable out of at least one of the aligned apertures in one of the first ends of the net support parts to thereby allow at least one of the net support parts to be foldable about the pivot points to the closed position;
using the anglers landing net by pivoting the two net support parts away from one another until the locking mechanism engages the two parts into the open position; and
storing the anglers landing net by disengaging the locking mechanism and folding the two net support parts towards one another; and selectively folding the folded two net support parts towards the handle.

15. A method comprising using the anglers landing net according to claim 1.

16. A method comprising using the anglers landing net according to claim 2.

17. A method comprising using the anglers landing net according to claim 3.

18. A method comprising using the anglers landing net according to claim 4.

19. A method comprising using the anglers landing net according to claim 5.

20. A method comprising using the anglers landing net according to claim 6.
